(19) United States
(12) Patent Application Publication
(10) Pub. No.: US 2007/0264574 A1
(43) Pub. Date: Nov. 15, 2007

(54) NEGATIVE ACTIVE MATERIAL INCLUDING METAL NANOCRYSTAL COMPOSITE, METHOD OF PREPARING THE SAME, AND ANODE AND LITHIUM BATTERY INCLUDING THE NEGATIVE ACTIVE MATERIAL

(76) Inventors: Han-su Kim, Yongin-si (KR); Jin-hwan Park, Yongin-si (KR); Seok-gwang Doo, Yongin-si (KR); Jae-phil Cho, Gumi-si (KR); Hyo-jin Lee, Gumi-si (KR); Yoo-jung Kwon, Gumi-si (KR)

Correspondence Address: CHRISTIE, PARKER & HALE, LLP, PO BOX 7068, PASADENA, CA, 91109-7068, US

(21) Appl. No.: 11/736,549

(22) Filed: Apr. 17, 2007

(30) Foreign Application Priority Data
May 9, 2006 (KR) 10-2006-0041640

(51) Int. Cl. H01M 4/62; H01M 4/58; B05D 5/12; B32B 5/16; B05D 7/00

(52) U.S. Cl. 429/231.8; 429/232; 428/403; 427/122; 427/216

(57) ABSTRACT

Negative active materials including metal nanocrystal composites comprising metal nanocrystals having an average particle diameter of about 20 nm or less and a carbon coating layer are provided. The negative active material includes metal nanocrystals coated by a carbon layer, which decreases the absolute value of the change in volume during charge/discharge and decreases the formation of cracks in the negative active material resulting from a difference in the volume change rate during charge/discharge between metal and carbon. Therefore, high charge/discharge capacities and improved capacity retention capabilities can be obtained.

### CROSS-REFERENCE TO RELATED PATENT APPLICATIONS

This application claims priority to and the benefit of Korean Patent Application No. 10-2006-0041640, filed on May 9, 2006 in the Korean Intellectual Property Office, the entire content of which is incorporated herein by reference.

### BACKGROUND OF THE INVENTION

1. Field of the Invention

The present invention relates to negative active materials, methods of preparing the same, and anodes and lithium batteries including the negative active materials.

2. Description of the Related Art

Non-aqueous electrolyte secondary batteries including lithium compounds acting as anodes have high voltages and high energy densities. Accordingly, much research has been carried out into non-aqueous electrolyte secondary batteries. In particular, when metallic lithium is used as an anode, the lithium battery has high capacity. However, when metallic lithium is used as an anode, lithium dendrites can form at the surface of the lithium during charging. This may cause decreases in the charging/discharging efficiency, and may cause a short circuit between the anode and cathode. In addition, metallic lithium is instable (i.e. it has high reactivity and it explosive), making it susceptible to heat and impact. Therefore, batteries including anodes formed of metallic lithium have not been commercialized.

To address the problems with use of metallic lithium, carbonaceous anodes have been developed. Carbonaceous anodes do not include metallic lithium, and use the lithium ions present in the electrolyte (which intercalate or deintercalate between crystal surfaces of the carbonaceous electrode during charge/discharge cycles) to perform oxidation and reduction reactions. Such a carbonaceous electrode is called a rocking-chair type electrode.

Use of carbonaceous anodes addresses many of the problems resulting from use of metallic lithium, and lithium batteries using these carbonaceous electrodes can be commercialized. However, as portable devices become smaller, more lightweight, and higher performing, higher capacities become required for secondary lithium batteries. In general, lithium batteries including carbonaceous anodes have naturally low battery capacities because of the porous structure of the carbon. For example, even graphite, which has the highest degree of crystallinity among carbonaceous materials, has a theoretical capacity of about 372 mAh/g when it forms LiC₆. In contrast, metallic lithium has a theoretical capacity of 3860 mAh/g. That is, graphite has a theoretical capacity as low as 10% of that of metallic lithium. Accordingly, although use of metallic anodes results in many problems, research into metallic lithium for use in anodes to improve battery capacity is actively being researched.

Lithium, lithium-aluminum, lithium-lead, lithium-tin, and lithium-silicon can provide higher electric capacity than carbonaceous materials. However, when these alloys or metals are used alone, lithium dendrites may precipitate. Accordingly, research is being carried out into an appropriate mixture of these materials with carbonaceous materials to improve electrical capacity while preventing short circuits.

However, when these alloys or metals are mixed with carbonaceous materials, the carbonaceous materials and the metallic materials show different expansion rates during oxidation and reduction reactions, and the metallic materials react with the electrolyte. When the battery is charged, lithium ions enter the anode and the anode expands to obtain a more compact structure. Then, when the battery is discharged, lithium ions leave the anode in an ionic state and the anode shrinks. Since the carbonaceous material and the metallic material have different expansion rates, the shrinking of the carbonaceous material and the metallic material result in the formation of empty spaces, and spacious cracks that generate electrically disconnected portions. This prevents electrons from moving smoothly, thereby decreasing the efficiency of the battery. In addition, when charged and discharged, the metallic material can react with the electrolyte, thereby decreasing the lifetime of the electrolyte which, in turn, decreases the lifetime and efficiency of the battery including the metallic material.

### SUMMARY OF THE INVENTION

In one embodiment of the present invention, a negative active material has high charging/discharging capacity and improved capacity retention capabilities.

In another embodiment of the present invention, an anode includes the negative active material.

In yet another embodiment of the present invention, a lithium battery includes the negative active material.

In still another embodiment of the present invention, a method of preparing the negative active material is provided.

According to one embodiment of the present invention, a negative active material comprises first metal nanocrystal composite particles including: metal nanocrystals having particle diameters of about 20 nm or less; and a carbon coating layer formed on the metal nanocrystals.

In another embodiment, the negative active material may include second metal nanocrystal composite clusters including a plurality of the first metal nanocrystal composite particles connected together by the carbon coating layer.

In one embodiment, the average particle diameter of the metal nanocrystals is about 10 nm or less.

In another embodiment, a standard deviation of particle diameters of the plurality of metal nanocrystals may be about ±20% or less from the average particle diameter of the metal nanocrystals.

In yet another embodiment, the average particle diameter of the second metal nanocrystal composite clusters may be less than about 1 μm.

In still another embodiment, the carbon coating layer covering the metal nanocrystals may have a uniform thickness.

In still yet another embodiment, the metal nanocrystals may have a core/shell structure.

In one embodiment, in the negative active material, the carbon coating layer may include less than about 0.1 wt % of hydrogen.

In another embodiment, in the negative active material, the metal nanocrystals may include a metal selected from Group 2 metals, Group 3 metals, Group 4 metals, alloys thereof and mixtures thereof.

In still another embodiment, in the negative active material, the metal nanocrystals may include a metal selected from Si, Sn, Ge, alloys thereof and mixtures thereof.

In yet another embodiment, in the negative active material, the metal nanocrystals include a metal that does not react with lithium. The metal that does not react with lithium may include a metal selected from Co, Fe, Ni, Cu, Ti and mixtures thereof.

According to another embodiment of the present invention, an anode includes the negative active material.

According to yet another embodiment of the present invention, a lithium battery includes an anode including the negative active material.

According to still another embodiment of the present invention, a method of preparing a negative active material includes: preparing metal nanocrystals capped with organic molecules; and carbonating the organic molecules to prepare a metal nanocrystal composite particle or cluster coated by a carbon layer.

In one embodiment, the metal nanocrystals capped with the organic molecules may be prepared using wet chemical synthesis.

In another embodiment, the organic molecules capping the metal nanocrystals may include compounds selected from C2-C10 alkyl groups, C3-C10 arylalkyl groups, C3-C10 alkylaryl groups, and C2-C10 alkoxy groups.

In one embodiment, the diameter of the metal nanocrystals may be about 20 nm or less.

In another embodiment, the organic molecules capping the metal nanocrystals may be carbonated by sintering the metal nanocrystals capped with the organic molecules in an inert atmosphere. The sintering temperature may range from about 500 to about 1000° C. The sintering time may range from about 1 to about 5 hours.

In yet another embodiment, the metal nanocrystals capped with the organic molecules may be prepared by reacting metal nanocrystal precursors with a reducing agent in a solution.

In one embodiment of the method, the metal of the metal nanocrystal precursors may be selected from Group 2 metals, Group 3 metals, Group 4 metals, alloys thereof and mixtures thereof.

In one embodiment, the metal of the metal nanocrystal precursors may include a metal selected from Si, Sn, Ge, Al, Pb, alloys thereof and mixtures thereof.

In another embodiment, the metal of the metal nanocrystal precursors may include a metal that does not react with lithium. The metal that does not react with lithium may include a metal selected from Co, Fe, Ni, Cu, Ti and mixtures thereof.

In yet another embodiment, the metal nanocrystal precursors may include compounds selected from metal halides.

In one embodiment, the reducing agent may be an organometallic compound. The organometallic compound may include a compound selected from sodium naphthalenide, potassium naphthalenide, sodium anthracenide, and potassium anthracenide.

In one embodiment, reacting the metal nanocrystal precursors with the reducing agent in a solution may include adding a compound having a functional group for capping the metal nanocrystals.

In another embodiment, the capping the metal nanocrystals with organic molecules may include reacting the metal nanocrystal precursors with the reducing agent in the presence of a Pt catalyst in a solution. The Pt catalyst may include a compound selected from H₂PtCl₆, (NH₄)₂PtCl₄, (NH₄)₂PtCl₆, K₂PtCl₄, K₂PtCl₆, and mixtures thereof.

Compared to conventional negative active materials including mixtures of metal particles and carbonaceous materials, the negative active materials according to the present invention include metal nanocrystals coated by carbon layers. This enables a decrease in the absolute value of the change in volume during charge/discharge cycles, thereby decreasing the formation of cracks in the negative active material resulting from the difference in volume change rates between the metal and the carbonaceous material. As a result, high charge/discharge capacities and improved capacity retention capabilities are obtained.

### BRIEF DESCRIPTION OF THE DRAWINGS

The above and other features and advantages of the present invention will be better understood by reference to the following detailed description when considered in conjunction with the attached drawings in which:

FIG. 1 is a high resolution transmission electron microscope (TEM) image of a first metal nanocrystal composite particle prepared according to Example 1;

FIG. 2 is a high resolution TEM image of a second metal nanocrystal composite prepared according to Example 1;

FIG. 3A is a Raman spectrum of graphite;

FIG. 3B is a Raman spectrum of a negative active material prepared according to Example 1;

FIG. 3C is a Raman spectrum of a negative active material prepared according to Example 5; and

FIG. 4 is a schematic perspective view of a lithium battery according to one embodiment of the present invention.

### DETAILED DESCRIPTION OF THE INVENTION

The present invention will now be described with reference to the accompanying drawings.

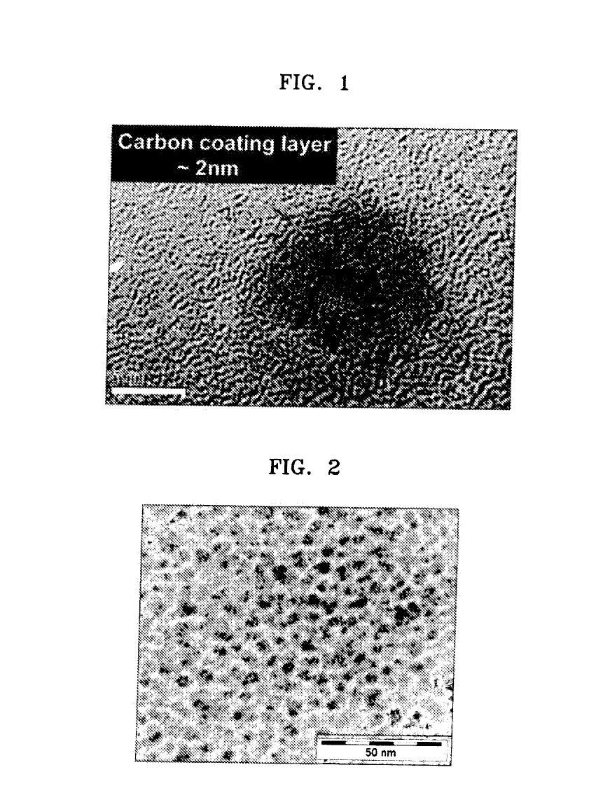

FIG. 1 is a high resolution TEM image of a negative active material according to one embodiment of the present invention. As shown in FIG. 1, the negative active material includes first metal nanocrystal composite particles having an average particle diameter of about 20 nm or less, and a carbon coating layer formed on the metal nanocrystal.

Referring to FIG. 1, each metal nanocrystal of the first metal nanocrystal composite particle has a pattern and a crystallinity, and the carbon coating layer is formed on the metal nanocrystal to a thickness.

When the average particle diameter of the metal nanocrystals is more than about 20 nm, the unique property of the metal nanocrystals is difficult to obtain and changes in volume of the metal nanocrystals during charge/discharge cycles may increase.

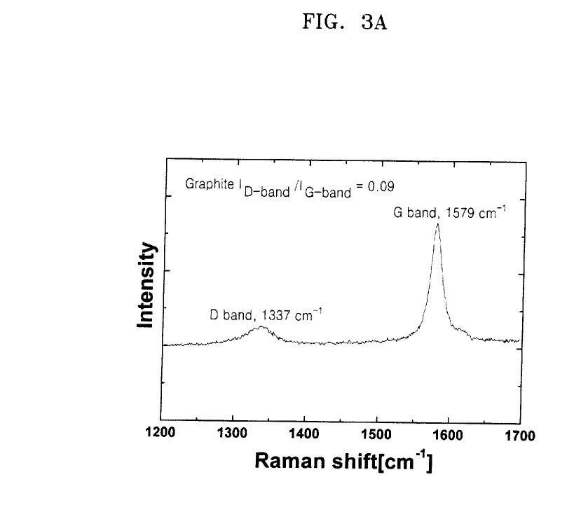

In addition, the negative active material according to one embodiment of the present invention can include second metal nanocrystal composite clusters, each of which includes a plurality of first metal nanocrystal composite particles connected together by the carbon coating layer, as illustrated in FIG. 2.

In one embodiment of the negative active material, the average particle diameter of the metal nanocrystals is about 10 nm or less. Within this range, the absolute value of the change in volume of the metal nanocrystal during charging/discharging decreases dramatically. However, when the average particle diameter of the metal nanocrystal is less than about 1 nm, it is difficult to effectively control the particle diameter and the metal nanocrystals are more reactive to oxygen and moisture making them susceptible to oxidation.

In another embodiment of the negative active material, the average deviation of particle diameters of the metal nanocrystals may be about ±20% or less of the average particle diameter of the metal nanocrystals. According to one embodiment of the present invention, metal nanocrystals contained in the negative active material are prepared in a colloidal state through chemical hydrothermal synthesis, so that particle size can be controlled. More uniform particle sizes can be obtained using this method than with other methods of preparing the metal nanocrystals.

Accordingly, in one embodiment of the present invention, the standard deviation of particle diameters of the metal nanocrystals can be controlled within about ±20% of the average particle diameter of the metal nanocrystals. When the metal nanocrystals have generally uniform particle sizes as described above, the change in volume of the metal nanocrystals during charge/discharge is substantially constant so that electrical disconnection can be prevented. When the standard deviation of particle diameters of the metal nanocrystals is more than about ±20%, there is a large difference between the change in volume of larger nanocrystals and the change in volume of smaller nanocrystals during charge/discharge. When such a difference exists, electrical disconnection can occur.

In the negative active material according to one embodiment of the present invention, the average particle diameter of the second metal nanocrystal composite clusters may be less than about 1 μm. When the average particle diameter of the second metal nanocrystal composite clusters is more than about 1 μm, the absolute value of the change in volume may increase, thereby decreasing capacity retention capabilities.

According to another embodiment of the present invention, the carbon coating layer having a thickness may substantially cover the metal nanocrystals. In one embodiment, the carbon coating layer entirely covers the metal nanocrystals. When the carbon coating layer entirely covers the metal nanocrystals, contact between the electrolyte and the metal nanocrystals is hindered.

In the negative active material according to another embodiment of the present invention, the carbon coating layer that covers the metal nanocrystals may have a lattice spacing d₀₀₂ of about 3.45 Å or more. In another embodiment, the carbon coating layer may be amorphous. When the carbon coating layer has high crystallization, the carbon coating layer may act as graphite and react with the electrolyte at its surface. On the other hand, when the carbon coating layer has low crystallization or is amorphous, the carbon coating layer does not react with the electrolyte during charge/discharge, and thus the electrolyte does not decompose and high charge/discharge efficiency can be obtained.

According to one embodiment of the present invention, the carbon coating layer may have a compact structure so that contact between the metal nanocrystals and the electrolyte can be prevented, and the reaction between the electrolyte and the metal nanocrystals can be hindered.

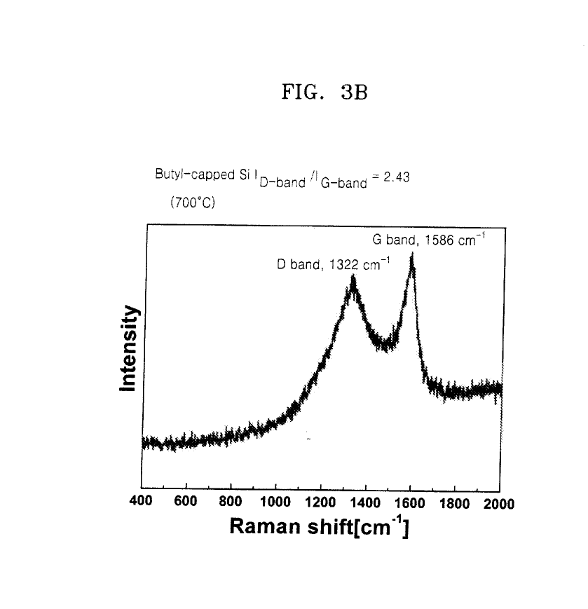

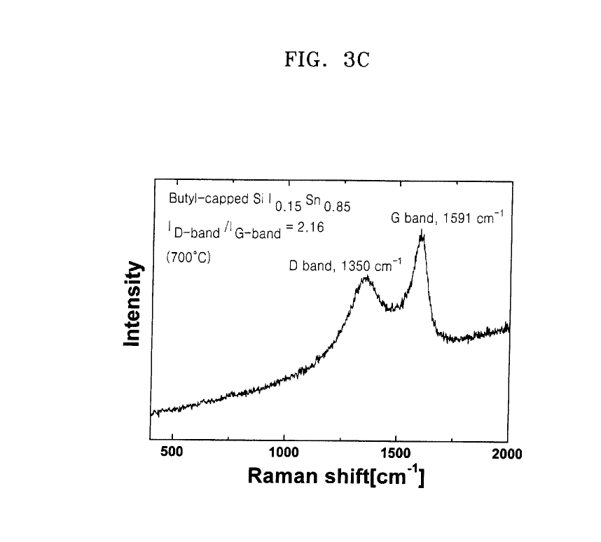

Referring to the Raman spectra of FIGS. 3B and 3C, it is found that the carbon coating layer used in one embodiment of the present invention entirely covers the metal nanocrystals. As illustrated in FIGS. 3B and 3C, the metal nanocrystal composite used in one embodiment of the present invention has a I(D-band)/I(G-band) value of 0.33 or more, which is a feature of carbon, and indicates no exposure of metal at the surface of the metal nanocrystal composite.

In one embodiment of the negative active material, the metal nanocrystals may have a core/shell structure, but the structure is not limited thereto. For example, the metal nanocrystals can have a multi-layer structure. When the metal nanocrystals have the core/shell structure, the shell can act as a coating layer. Accordingly, the core can be formed of a metal that has high electrical capacity but low stability during charge/discharge, and the shell can be formed of a metal that has low electrical capacity but high stability during charge/discharge.

In another embodiment of the negative active material, the amount of hydrogen contained in the carbon coating layer may be about 0.1 wt % or less. Since the carbon coating layer can be obtained by carbonating an organic molecule, use of less hydrogen is desired. When the amount of hydrogen contained in the carbon coating layer is more than about 0.1 wt %, an increase irreversible capacity due to the chemical reaction of hydrogen and lithium may occur.

According to another embodiment of the negative active material, the metal nanocrystals may include a metal selected from Group 2 metals, Group 3 metals, Group 4 metals, alloys thereof and mixtures thereof. In one embodiment, for example, the metal nanocrystals may include a metal selected from Si, Sn, Ge, Pb, alloys thereof and mixtures thereof. In another embodiment, the metal nanocrystals may further include a metal that does not react with lithium. When the metal nanocrystals have a core/shell structure, these metals or alloys included in the metal nanocrystal can be used to form the core and the shell. Nonlimiting examples of suitable metals that do not react with lithium include Co, Fe, Ni, Cu, Ti and mixtures thereof.

An anode according to one embodiment of the present invention includes the negative active material described above. The anode can be formed by molding an anode material mixture including the negative active material and a binder into a predetermined shape, or by coating the anode material mixture on a collector, such as copper foil.

Specifically, an anode material composition is prepared and then directly coated on a copper foil collector to obtain an anode plate. Alternatively, the prepared anode material composition is cast on a separate support to form a negative active material film, and then the negative active material film is detached from the support and laminated on a copper foil collector to obtain an anode plate. However, the anode according to the present invention is not limited thereto and can take any form.

Generally, to obtain high capacity, a battery is charged and discharged with a great amount of current. As a result, the material used to form the battery must have low electrical resistance. In general, various types of conducting agents are used in the preparation of a battery to reduce the resistance of the battery. Nonlimiting examples of suitable conducting agents include carbon black, graphite microparticles, and the like. However, according to one embodiment of the present invention, conducting agents are not used because the anode itself is highly conductive.

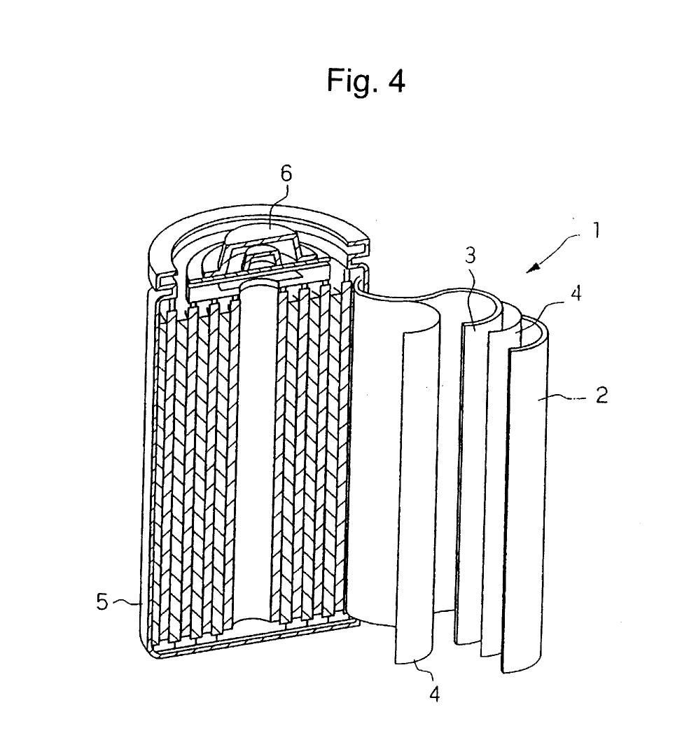

As shown in FIG. 4, a lithium battery 1 includes an electrode assembly comprising a cathode 2, an anode 3 and a separator 4. The electrode assembly is wound and contained in a battery case 5, which is then sealed with a cap assembly 6. According to one embodiment of the present invention, a lithium battery includes the anode prepared as described above.

According to one embodiment of the present invention, a method of preparing a lithium battery includes first preparing a positive active material composition by mixing a positive active material, a conducting agent, a binder, and a solvent. The positive active material composition is directly coated on a metal collector and then dried to prepare a cathode plate. Alternatively, the positive active material composition can be cast on a separate support to form a positive active material composition film, which film is then detached from the support and laminated on a metal collector to prepare a cathode plate.

The positive active material can be any metal oxide that includes lithium and that is commonly used in the art. Nonlimiting examples of suitable positive active materials include LiCoO₂, LiMnₓO₂ₓ, LiNiₓ₋₁MnₓO₂ₓ (where x=1 or 2), Ni_{1-x-y}CoₓMn_{y}O₂ (where 0≦x≦0.5, 0≦y≦0.5), and the like. For example, the positive active material can be LiMn₂O₄, LiCoO₂, LiNiO₂, LiFeO₂, V₂O₅, TiS, or MoS, in which lithium can be oxidized and reduced.

One nonlimiting example of a suitable conducting agent is carbon black. Nonlimiting examples of suitable binders include vinylidenfluoride/hexafluoropropylene copolymers, polyvinylidenefluoride, polyacrylonitrile, polymethylmethacrylate, polytetrafluoroethylene and mixtures thereof. Other nonlimiting examples of suitable binders include styrene butadiene rubber-based polymers. Nonlimiting examples of suitable solvents include N-methyl-pyrrolidone, acetone, and water. The amounts of the positive active material, the conducting agent, and the binder are those commonly used in the art.

The separator can be any separator conventionally used in lithium batteries. For example, a separator having low resistance to the flow of ions in an electrolyte and high electrolyte retaining capabilities can be used. Nonlimiting examples of suitable separators include woven or non-woven fabrics of glass fibers, polyester, Teflon, polyethylene, polypropylene, polytetrafluoroethylene (PTFE), and combinations thereof. For example, a lithium ion battery may use a foldable separator formed of polyethylene, polypropylene, or the like, and a lithium ion polymer battery may use a separator having excellent organic electrolyte retaining abilities.

According to one embodiment, a method of preparing a separator includes mixing a polymer resin, a filler, and a solvent to form a separator composition. Then, the separator composition is directly coated on an electrode and dried to form a separator film. Alternatively, the separator composition is cast on a separate support and dried to form a separator film, which film is then detached from the support and laminated on an electrode.

The polymer resin is not limited and can be any binding agent commonly used with electrode plates. Nonlimiting examples of suitable polymer resins include vinylidenefluoride/hexafluoropropylene copolymers, polyvinylidenefluoride, polyacrylonitrile, polymethylmethacrylate, and mixtures thereof.

The electrolyte includes a lithium salt dissolved in a solvent. Nonlimiting examples of suitable lithium salts include LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO2)(C_{y}F_{2y+1}SO₂) where x and y are natural numbers, LiCl, and LiI. Nonlimiting examples of suitable solvents include propylene carbonate, ethylene carbonate, diethyl carbonate, ethyl methyl carbonate, methyl propyl carbonate, butylene carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethylsulfoxide, dioxane, 1,2-dimethoxyethane, sulfolane, dichloroethane, chlorobenzene, nitrobenzene, dimethylcarbonate, methylethylcarbonate, diethylcarbonate, methylpropylcarbonate, methylisopropylcarbonate, ethylpropylcarbonate, dipropylcarbonate, dibutylcarbonate, diethyleneglycol, dimethyl ether, and combinations thereof.

The separator is placed between the cathode plate and the anode plate to form a battery assembly. The battery assembly is wound or folded and placed in a cylindrical or rectangular battery case. The organic electrolyte according to one embodiment of the present invention is then injected into the battery case to complete a lithium ion battery.

Alternatively, battery assemblies can be stacked in a bi-cell structure and then immersed in an organic electrolyte. The resultant product is sealed in a pouch to complete a lithium ion polymer battery.

A method of preparing a negative active material according to one embodiment of the present invention includes preparing metal nanocrystals capped with organic molecules, and carbonating the organic molecules that cap the metal nanocrystals to prepare a metal nanocrystal composite coated by a carbon layer.

According to this embodiment, the metal nanocrystals capped with the organic molecules may be obtained in a colloidal state through wet chemical synthesis. A conventional method of wet chemical synthesis of metal nanocrystals is disclosed in, for example, Science, 2000, 287, 1989-1992, the entire content of which is incorporated herein by reference.

According to one embodiment of the present invention, a method of preparing a negative active material includes reacting a metal nanocrystal precursor with a reducing agent in a solution to prepare metal nanocrystals capped with organic molecules.

Nonlimiting examples of suitable metals for the metal nanocrystal precursor include Group 2 metals, Group 3 metals, Group 4 metals, alloys thereof and combinations thereof. Specific nonlimiting examples of suitable metals include Si, Sn, Ge, Al, Pb, alloys thereof and combinations thereof.

According to one embodiment, the metal nanocrystal precursor may include a metal that does not react with lithium. Nonlimiting examples of metals that do not react with lithium include Co, Fe, Ni, Cu, Ti and combinations thereof.

In one embodiment, the metal nanocrystal precursor may be a metal halide, such as SiCl₄, SnCl₄, and GeCl₄. However, the metal nanocrystal precursor is not limited thereto and can be any precursor used in the art that provides a metal nanocrystal.

In one embodiment, the reducing agent may be an organometallic compound. Nonlimiting examples of suitable organometallic compounds include sodium naphthalenide, potassium naphthalenide, sodium anthracenide and potassium anthracenide.

According to one embodiment, the metal nanocrystal precursor can be reacted with the reducing agent in the presence of a Pt catalyst in a solution to prepare metal nanocrystals capped with organic molecules. The Pt catalyst promotes formation of metal nanocrystals. That is, the Pt catalyst increases the growth speed of crystals from the metal nanocrystal precursor so that more metal nanocrystals can be obtained. Nonlimiting examples of suitable Pt catalysts include H₂PtCl₆, (NH₄)₂PtCl₄, (NH₄)₂PtCl₆, K₂PtCl₄, and K₂PtCl₆. The Pt catalyst can be any Pt catalyst that is used in the art.

The metal nanocrystals capped with organic molecules obtained as described above can be used in any field where their physical properties are useful.

According to one embodiment of the method of preparing a negative active material, the organic molecule capping the metal nanocrystals can be any material that increases the dispersion of metal nanocrystals. Nonlimiting examples of suitable organic molecules for capping the metal nanocrystals include C₂-C₁₀ alkyl, C₃-C₁₀ arylalkyls, C₃-C₁₀ alkylaryls, and C₂-C₁₀ alkoxys.

In one embodiment of the method of preparing a negative active material, the average particle diameter of the metal nanocrystals may be about 20 nm or less. In another embodiment, the average particle diameter of the metal nanocrystals may be about 10 nm or less.

According to another embodiment of the method of preparing a negative active material, the capping organic molecules are carbonated by sintering the metal nanocrystals capped with the organic molecules in an inert atmosphere. The inert atmosphere can be an inert gas atmosphere using Ar or N, or a vacuum atmosphere. The sintering temperature may range from about 500 to about 1000° C., and the sintering time may range from about 1 to about 5 hours.

When the sintering temperature is lower than about 500° C., the organic molecule is insufficiently carbonated and irreversible capacity may increase. On the other hand, when the sintering temperature is greater than about 1000° C., an impurity, such as SiC, may be formed and capacity may decrease.

When the sintering time is longer than about 5 hours, the sintering process is unnecessarily prolonged, thereby increasing manufacturing costs. On the other hand, when the sintering time is shorter than about 1 hour, the organic molecules are insufficiently carbonated and irreversible capacity may increase.

The present invention will now be described with reference to the following examples. These examples are for illustrative purposes only and are not intended to limit the scope of the present invention.

### Preparation of Negative Active Material

### EXAMPLE 1

4.6 g of SiCl₄ was dissolved in 50 ml of ethylene glycol dimethyl ether to form a first solution, and the first solution was stirred. A second solution of sodium naphthalenide dissolved in ethylene glycol dimethyl ether was prepared by adding 5.4 g of sodium and 19.38 g of naphthalene to 100 ml of ethylene glycol dimethyl ether, and the second solution was stirred all night. The second solution was quickly added to the first solution using a cannula while the first solution was stirring. As a result, a black dispersion solution was obtained. The black dispersion solution was stirred for 30 minutes. Then, 60 ml of butyllithium was added to the black dispersion solution, thereby quickly obtaining an amber-colored solution including a white precipitate. Subsequently, the solvent and naphthalene were removed from the amber-colored solution by placing the solution in a heated tank and using a rotary evaporator under reduced pressure. A light yellow solid was obtained as a result. The light yellow solid was extracted using hexane, and then washed three times using slightly acidic distilled water. Then, the solvent was removed from the washed result to obtain a viscous yellow solid.

1 g of the viscous yellow solid was sintered at 700° C. for five hours in a vacuum atmosphere to completely carbonate the butyl group. The sintered product was pulverized using a mortar to obtain 0.1 g of a metal nanocrystal composite powder coated by a carbon layer.

### EXAMPLE 2

A metal nanocrystal composite powder was prepared as in Example 1, except that the sintering temperature was 900° C. instead of 700° C.

### EXAMPLE 3

A metal nanocrystal composite powder was prepared as in Example 1, except that the sintering temperature was 1000° C. instead of 700° C.

### EXAMPLE 4

4.6 g of SiCl₄ and 1.84 g of SnCl₄ were dissolved in 50 ml of ethylene glycol dimethyl ether to form a first solution, and the first solution was stirred. A second solution of sodium naphthalenide dissolved in ethylene glycol dimethyl ether was prepared by adding 5.4 g of sodium and 19.38 g of naphthalene to 100 ml of ethylene glycol dimethyl ether, and the second solution was stirred all night. The second solution was quickly added to the first solution using a cannula while the first solution was stirring. As a result, a black dispersion solution was obtained. The black dispersion solution was stirred for 30 minutes. Then, 60 ml of butyllithium was added to the black dispersion solution, thereby quickly obtaining an amber-colored solution including a white precipitate. Subsequently, the solvent and naphthalene were removed from the amber-colored solution by placing the solution in a heated tank and using a rotary evaporator under reduced pressure. As a result, a light yellow solid was obtained. The light yellow solid was extracted using hexane, and then washed three times using slightly acidic distilled water. Then, the solvent was removed from the washed result to obtain a viscous yellow solid.

1 g of the viscous yellow solid was sintered at 600° C. for five hours in a vacuum atmosphere to completely carbonate the butyl group. The sintered product was pulverized using a mortar to obtain 0.12 g of a metal nanocrystal composite powder coated by a carbon layer. In the metal nanocrystal composite powder, the mole ratio of Sn:Si was 0.85:0.15.

### EXAMPLE 5

A metal nanocrystal composite powder was prepared as in Example 4, except that the sintering temperature was 700° C. instead of 600° C.

### EXAMPLE 6

A metal nanocrystal composite powder was prepared as in Example 4, except that the sintering temperature was 900° C. instead of 600° C.

### EXAMPLE 7

A metal nanocrystal composite powder was prepared as in Example 4, except that the sintering temperature was 1000° C. instead of 600° C.

### EXAMPLE 8

8.58 g of GeCl₄ was dissolved in 50 ml of ethylene glycol dimethyl ether to form a first solution, and the first solution was stirred. A second solution of sodium naphthalenide dissolved in ethylene glycol dimethyl ether was prepared by adding 5.4 g of sodium and 19.38 g of naphthalene to 100 ml of ethylene glycol dimethyl ether, and the second solution was stirred all night. The second solution was quickly added to the first solution using a cannula while the first solution was stirring. As a result, a black dispersion solution was obtained. The black dispersion solution was stirred for 30 minutes. Then, 60 ml of butyllithium was added to the black dispersion solution, thereby quickly obtaining an amber-colored solution including a white precipitate. Subsequently, the solvent and naphthalene were removed from the amber-colored solution by placing the solution in a heated tank and using a rotary evaporator under reduced pressure. As a result, a light yellow solid was obtained. The light yellow solid was extracted using hexane, and then washed three times using slightly acidic distilled water. Then, the solvent was removed from the washed result to obtain a viscous yellow solid.

1 g of the viscous yellow solid was sintered at 400° C. for five hours in a vacuum atmosphere to completely carbonate the butyl group. The sintered product was pulverized using a mortar to obtain 1.38 g of a metal nanocrystal composite powder coated by a carbon layer.

### EXAMPLE 9

A metal nanocrystal composite powder was prepared as in Example 8, except that the sintering was performed at 600° C. for 3 hours instead of at 400° C. for 5 hours.

### EXAMPLE 10

A metal nanocrystal composite powder was prepared as in Example 8, except that the sintering was performed at 600° C. for 9 hours instead of at 400° C. for 5 hours.

### EXAMPLE 11

A metal nanocrystal composite powder was prepared as in Example 8, except that the sintering was performed at 800° C. for 3 hours instead of at 400° C. for 5 hours.

### COMPARATIVE EXAMPLE 1

Silicon particles having an average diameter of 50 nm obtained from US Nano and Amorphous Materials, Inc. were used as a negative active material.

### COMPARATIVE EXAMPLE 2

4.6 g of SiCl₄ and 1.84 g of SnCl₄ were dissolved in 50 ml of ethylene glycol dimethyl ether to form a first solution, and the first solution was stirred. A second solution of sodium naphthalenide dissolved in ethylene glycol dimethyl ether was prepared by adding 5.4 g of sodium and 19.38 g of naphthalene to 100 ml of ethylene glycol dimethyl ether, and the second solution was stirred all night. The second solution was quickly added to the first solution using a cannula while the first solution was stirring. As a result, a black dispersion solution was obtained. The black dispersion solution was stirred for 30 minutes. Subsequently, the solvent and naphthalene were removed from the amber-colored solution by placing the solution in a heated tank and using a rotary evaporator under reduced pressure. As a result, a light yellow solid was obtained. The light yellow solid was extracted using hexane, and then washed three times using slightly acidic distilled water. Then, the solvent was removed from the washed result to obtain a viscous yellow solid.

1 g of the viscous yellow solid was sintered at 600° C. for five hours in a vacuum atmosphere to completely carbonate the butyl group. The sintered product was pulverized using a mortar to obtain 0.082 g of a metal nanocrystal composite powder coated by a carbon layer. In the metal nanocrystal composite, the mole ratio of Sn:Si was 0.85:0.15.

### Preparation of Anode

### EXAMPLE 12

0.6 g of the active material powder obtained according to Example 1, 0.2 g of polyvinylidene fluoride (PVDF), and carbon black (Super-p, MMM Inc.) acting as a conducing agent were mixed together. Then, 10 mL of N-methylpyrrolidone (NMP) was added thereto. The resultant mixture was stirred using a mechanical agitator for 30 minutes to prepare a slurry.

The slurry was coated on a Cu collector using a doctor blade to a thickness of about 200 μm, dried at room temperature and then dried again at 110° C. under vacuum, thereby obtaining an anode plate.

### EXAMPLE 13

An anode plate was prepared as in Example 12, except that the active material powder obtained in Example 2 was used.

### EXAMPLE 14

An anode plate was prepared as in Example 12, except that the active material powder obtained in Example 3 was used.

### EXAMPLE 15

An anode plate was prepared as in Example 12, except that the active material powder obtained in Example 4 was used.

### EXAMPLE 16

An anode plate was prepared as in Example 12, except that the active material powder obtained in Example 5 was used.

### EXAMPLE 17

An anode plate was prepared as in Example 12, except that the active material powder obtained in Example 6 was used.

### EXAMPLE 18

An anode plate was prepared as in Example 12, except that the active material powder obtained in Example 7 was used.

### EXAMPLE 19

An anode plate was prepared as in Example 12, except that the active material powder obtained in Example 8 was used.

### EXAMPLE 20

An anode plate was prepared as in Example 12, except that the active material powder obtained in Example 9 was used.

### EXAMPLE 21

An anode plate was prepared as in Example 12, except that the active material powder obtained in Example 10 was used.

### EXAMPLE 22

An anode plate was prepared as in Example 12, except that the active material powder obtained in Example 11 was used.

### COMPARATIVE EXAMPLE 3

An anode plate was prepared as in Example 12, except that the active material powder obtained in Comparative Example 1 was used.

### COMPARATIVE EXAMPLE 4

An anode plate was prepared as in Example 12, except that the active material powder obtained in Comparative Example 2 was used.

### Preparation for Lithium Battery

### EXAMPLES 23

The anode plate prepared according to Example 12, a lithium metal acting as a counter electrode, a PTFE separator, and 1 M LiPF₆ dissolved in ethylene carbonate (EC)+diethyl carbonate (DEC)(3:7) acting as an electrolyte were used to prepare a 2015-type coin cell.

### EXAMPLE 24

A coin cell was prepared as in Example 23, except that the anode plate prepared according to Example 13 was used.

### EXAMPLE 25

A coin cell was prepared as in Example 23, except that the anode plate prepared according to Example 14 was used.

### EXAMPLE 26

A coin cell was prepared as in Example 23, except that the anode plate prepared according to Example 15 was used.

### EXAMPLE 27

A coin cell was prepared as in Example 23, except that the anode plate prepared according to Example 16 was used.

### EXAMPLE 28

A coin cell was prepared as in Example 23, except that the anode plate prepared according to Example 17 was used.

### EXAMPLE 29

A coin cell was prepared as in Example 23, except that the anode plate prepared according to Example 18 was used.

### EXAMPLE 30

A coin cell was prepared as in Example 23, except that the anode plate prepared according to Example 19 was used.

### EXAMPLE 31

A coin cell was prepared as in Example 23, except that the anode plate prepared according to Example 20 was used.

### EXAMPLE 32

A coin cell was prepared as in Example 23, except that the anode plate prepared according to Example 21 was used.

### EXAMPLE 33

A coin cell was prepared as in Example 23, except that the anode plate prepared according to Example 22 was used.

### COMPARATIVE EXAMPLE 5

A coin cell was prepared as in Example 23, except that the anode plate prepared according to Comparative Example 3 was used.

### COMPARATIVE EXAMPLE 6

A coin cell was prepared as in Example 23, except that the anode plate prepared according to Comparative Example 4 was used.

### Charge/Discharge Tests

Each coin cell prepared according to Examples 23-33 and Comparative Examples 5-6 was charged with a constant current of 50 mA per 1 g of active material until the voltage reached 0.001 V with respect to the Li electrode. Each coin cell was then charged with a constant voltage of 0.001 V until the current decreased to 5 mA per 1 g of the active material.

When the coin cell was completely charged, the coin cell was allowed to sit for about 30 minutes. Then, the coin cell was discharged with a constant current of 50 mA per 1 g of the active material until the voltage reached 1.5 V.

Test results obtained for the coin cells prepared according to Examples 23-33 and Comparative Examples 5-6 are shown in Table 1 below.

TABLE 1

| | Initial | |
|---|---|---|
| Used Negative | Capacity | Capacity Retention Rate after 50 |
| Active Material | (mAh/g) | charge/discharge Cycles (%) |
| Example 1 | 600 | 91 |
| Example 2 | 1020 | 86 |
| Example 3 | 708 | 90 |
| Example 4 | 450 | 86 |
| Example 5 | 560 | 91 |
| Example 6 | 730 | 62 |
| Example 7 | 760 | 63 |
| Example 8 | 320 | 96 |
| Example 9 | 1100 | 80 |
| Example 10 | 990 | 60 |
| Example 11 | 735 | 54 |
| Comparative | 225 | 10 |
| Example 1 | | |
| Comparative | 600 | 17 |
| Example 2 | | |

As shown in Table 1, the coin cells that included the negative active materials prepared according to Examples 1 through 11 (each including a metal nanocrystal composite coated by a carbon coating layer) showed an initial capacity of more than 400 mAh/g, except for the coin cell using the negative active material prepared according to Example 8. That is, most of the coin cells using a negative active material including a metal nanocrystal composite coated by a carbon layer had an initial capacity greater than 375 mAh/g (the theoretical capacity of carbon). In addition, the coin cells that included the negative active materials prepared according to Examples 1 through 11 showed a capacity retention rate of 54% after 50 charge/discharge cycles.

On the other hand, the coin cell that included the silicon particles having an average particle size of 50 nm according to Comparative Example 1 showed a low initial capacity of 225 mAh/g, and a low capacity retention rate after 50 charge/discharge cycles of 10%. The coin cell that included the negative active material including a metal nanocrystal that was not coated by a carbon layer prepared according to Comparative Example 2, showed an initial capacity as high as 600 mAh/g, but the capacity retention rate after 50 charge/discharge cycles was as low as 17%.

Most metal nanocrystals coated by carbon layers according to the present invention can be substantially used for intercalation/deintercalation of lithium ions because the metal particles are small in size and are separated from each other by the carbon layer. Accordingly, coin cells using such metal nanocrystals had higher initial capacity than coin cells using large metals (Comparative Example 1).

The metal nanocrystals according to the present invention have small absolute values of changes in volume during charge/discharge and are substantially uniform in size, thereby preventing electrical disconnection during charge/discharge and obtaining high capacity retention rates.

A negative active material according to one embodiment of the present invention includes metal nanocrystals coated by carbon layers which decreases the absolute value of the change in volume during charge/discharge and decreases the formation of cracks in the negative active material resulting from differences in the changes in volume between metal and carbon materials during charge/discharge. Therefore, high charge/discharge capacities and improved capacity retention capabilities can be obtained.

While the present invention has been illustrated and described with reference to certain exemplary embodiments, it will be understood by those of ordinary skill in the art that various modifications and changes may be made to the described embodiments without departing from the spirit and scope of the present invention as defined by the following claims.

What is claimed is:

1. A negative active material comprising a plurality of first metal nanocrystal composite particles, each first metal nanocrystal composite particle comprising:
a metal nanocrystal; and
a carbon coating layer formed on the metal nanocrystal,
wherein the metal nanocrystals in the plurality of first metal nanocrystal composite particles have an average particle diameter of about 20 nm or less.

2. The negative active material of claim 1, further comprising second metal nanocrystal composite clusters, each second metal nanocrystal composite cluster comprising a plurality of first metal nanocrystal composite particles connected together by the carbon coating layer.

3. The negative active material of claim 2, wherein an average particle diameter of the metal nanocrystals is about 10 nm or less.

4. The negative active material of claim 2, wherein a standard deviation of particle diameters of the metal nanocrystals is about ±20% or less from the average particle diameter of the metal nanocrystals.

5. The negative active material of claim 2, wherein an average particle diameter of the second metal nanocrystal composite clusters is less than about 1 μm.

6. The negative active material of claim 1, wherein the carbon coating layer covering the metal nanocrystals has a uniform thickness.

7. The negative active material of claim 1, wherein the metal nanocrystals have a core/shell structure.

8. The negative active material of claim 1, wherein the carbon coating layer comprises less than about 0.1 wt % of hydrogen.

9. The negative active material of claim 1, wherein the metal nanocrystals comprise a metal selected from the group consisting of Group 2 metals, Group 3 metals, Group 4 metals, alloys thereof and combinations thereof.

10. The negative active material of claim 1, wherein the metal nanocrystals comprise a metal selected from the group consisting of Si, Sn, Ge, alloys thereof and combinations thereof.

11. The negative active material of claim 1, wherein the metal nanocrystals comprise a metal that does not react with lithium.

12. The negative active material of claim 11, wherein the metal that does not react with lithium comprises a metal selected from the group consisting of Co, Fe, Ni, Cu, Ti and combinations thereof.

13. An anode comprising the negative active material of claim 1.

14. A lithium battery comprising the anode of claim 13.

15. A method of preparing a negative active material, the method comprising:
preparing metal nanocrystals capped with organic molecules; and
carbonating the organic molecules to prepare metal nanocrystal composites coated by carbon layers.

16. The method of claim 15, wherein the metal nanocrystals capped with the organic molecules are prepared by wet chemical synthesis.

17. The method of claim 15, wherein the organic molecules capping the metal nanocrystals comprise compounds selected from the group consisting of C₂-C₁₀ alkyls, C₃-C₁₀ arylalkyls, C₃-C₁₀ alkylaryls, and C₂-C₁₀ alkoxys.

18. The method of claim 15, wherein the average particle diameter of the metal nanocrystals is about 20 nm or less.

19. The method of claim 15, wherein the organic molecules capping the metal nanocrystals are carbonated by sintering the metal nanocrystals capped with the organic molecules in an inert atmosphere.

20. The method of claim 19, wherein the sintering temperature ranges from about 500 to about 1000° C.

21. The method of claim 19, wherein the sintering is performed for about 1 to about 5 hours.

22. The method of claim 15, wherein the metal nanocrystals capped with the organic molecules are prepared by reacting a metal nanocrystal precursor with a reducing agent in a solution.

23. The method of claim 22, wherein a metal of the metal nanocrystal precursor is selected from the group consisting of Group 2 metals, Group 3 metals, Group 4 metals, alloys thereof and combinations thereof.

24. The method of claim 22, wherein a metal of the metal nanocrystal precursor comprises a metal selected from the group consisting of Si, Sn, Ge, Al, Pb, alloys thereof and combinations thereof.

25. The method of claim 22, wherein a metal of the metal nanocrystal precursor comprises a metal that does not react with lithium.

26. The method of claim 25, wherein the metal that does not react with lithium comprises a metal selected from the group consisting of Co, Fe, Ni, Cu, Ti and combinations thereof.

27. The method of claim 22, wherein the metal nanocrystal precursor comprises a metal halide.

28. The method of claim 22, wherein the reducing agent is an organometallic compound.

29. The method of claim 28, wherein the organometallic compound comprises at least one compound selected from the group consisting of sodium naphthalenide, potassium naphthalenide, sodium anthracenide, and potassium anthracenide.

30. The method of claim 22, wherein reacting the metal nanocrystal precursor with the reducing agent in a solution comprises adding a compound having a functional group for capping the metal nanocrystals to the solution.

31. The method of claim 15, wherein capping the metal nanocrystals with the organic molecules comprises reacting the metal nanocrystal precursor with a reducing agent in the presence of a Pt catalyst in a solution.

32. The method of claim 31, wherein the Pt catalyst is selected from the group consisting of H₂PtCl₆, (NH₄)₂PtCl₄, (NH₄)₂PtCl₆, K₂PtCl₄, K₂PtCl₆, and combinations thereof.
